(19) United States
(12) Patent Application Publication
(10) Pub. No.: US 2021/0060707 A1
(43) Pub. Date: Mar. 4, 2021

(54) BESSEL BEAM WITH AXICON FOR CUTTING TRANSPARENT MATERIAL

(71) Applicant: Lumentum Operations LLC, San Jose, CA (US)

(72) Inventors: Long ZHANG, Shenzhen (CN); Andreas OEHLER, Zurich (CH); Jan-Willem PIETERSE, San Jose, CA (US)

(21) Appl. No.: 16/915,373

(22) Filed: Jun. 29, 2020

(30) Foreign Application Priority Data
Aug. 28, 2019 (CN) PCT/CN2019/102977
Jan. 2, 2020 (CN) PCT/CN2020/070126

(51) Int. Cl. B23K 26/38; B23K 26/53

(52) U.S. Cl. CPC B23K 26/38; B23K 2103/54; B23K 26/53

(57) ABSTRACT

A Bessel beam laser-cutting system may comprise an ultrafast laser light source, an axicon, a first lens, and a second lens. The ultrafast light source may be configured to emit a beam into the axicon. The axicon may be configured to diffract the beam into a first/primary Bessel beam in a near field of the axicon and an annular beam in a far field of the axicon. The first lens may be configured to focus the annular beam. The second lens may be configured to converge the focused annular beam into a second/secondary Bessel beam to modify a transparent material, wherein a modification depth of the modification generated by the second/secondary Bessel beam is to be within a range of tens of micrometers to several millimeters inside the transparent material.

### RELATED APPLICATION(S)

This application claims priority to Patent Cooperation Treaty (PCT) Application No. PCT/CN2019/102977, filed on Aug. 28, 2019, and entitled “BESSEL BEAM WITH AXICON FOR GLASS CUTTING,” the content of which is incorporated by reference herein in its entirety.

This application claims priority to PCT Application No. PCT/CN2020/070126, filed on Jan. 2, 2020, and entitled “BESSEL BEAM WITH AXICON FOR CUTTING TRANSPARENT MATERIAL,” the content of which is incorporated by reference herein in its entirety.

### TECHNICAL FIELD

The present disclosure relates to a system for laser-cutting a transparent material, and in particular to a system utilizing a Bessel beam generated with an axicon to cut transparent materials such as glass. Transparent in this connotation means transparent for the used laser-wavelength. It might be opaque for the human eye.

### BACKGROUND

A Bessel beam is a non-diffractive laser beam with an extended depth of field (also referred to as a Rayleigh range) and a characteristic of self-reconstruction. The extended depth of field enables generation of an elongated focal area with a uniform distribution of energy.

### SUMMARY

According to some implementations, a Bessel beam laser-cutting system may comprise an ultrafast laser light source configured to emit a beam into an axicon; the axicon configured to diffract the beam into a first Bessel beam in a near field of the axicon and an annular beam in a far field of the axicon; a first lens configured to focus the annular beam; and a second lens configured to converge the focused annular beam into a second Bessel beam to modify a transparent material, wherein a depth of the modification generated by the second Bessel beam is to be within a range of tens of micrometers to several millimeters inside the transparent material.

According to some implementations, a cutting system for transparent materials may comprise an ultrafast laser light source configured to emit an ultrashort laser pulse (e.g., a laser pulse with a pulse duration ranging from a few femtoseconds to some hundred picoseconds) into an axicon; the axicon configured to diffract the ultrashort laser pulse into a first Bessel beam in a near field of the axicon and an annular beam in a far field of the axicon, wherein a length of a depth of field of the first Bessel beam is to be within a range of 10 millimeters in air to 1 meter in air; a first lens configured to focus the annular beam; and a second lens configured to converge the focused annular beam into a second Bessel beam to modify a transparent material, wherein a length of a depth of field of the second Bessel beam is to be within a range of 30 micrometers in air to 15 millimeters in air, and wherein a cutting depth of the second Bessel beam is to be within a range of 20 micrometers to 10 millimeters in the transparent material.

According to some implementations, a Bessel beam cutting system may comprise a light source configured to emit a beam into an axicon, wherein a diameter of the beam is associated with a clear aperture of the axicon (e.g. the diameter would less than or equal to 22.8 millimeters for a 85% clear aperture of a 1 inch axicon); the axicon configured to diffract the input beam into a first Bessel beam in a near field of the axicon and an annular beam in a far field of the axicon, wherein an apex angle of the axicon is configured to be within a range of 100 to 180 degrees; and a first lens and a second lens configured to demagnify the annular beam into a second Bessel beam to modify a transparent material, wherein an axial magnification amount of the annular beam by the first lens and the second lens is configured to be within a range of 1/2500 to 1, and wherein a modification depth of the second Bessel beam is to be within a range of 30 micrometers to 10 millimeters in the transparent material.

### BRIEF DESCRIPTION OF THE DRAWING

FIG. 1 is a diagram of an example implementation described herein.

### DETAILED DESCRIPTION

The following detailed description of example implementations refers to the accompanying drawing.

In some instances, a laser-based cutting system may be used to cut a particular geometry in a transparent material, such as glass. For example, existing laser-based cutting systems include a high aberration laser-based cutting system, a polarization induced focal shifts laser-based cutting system, a holographic refraction or reflection laser-based cutting system, and/or the like for cutting holes in a transparent material. However, in many cases, the existing laser-based cutting systems, when cutting a particular geometry in the transparent material, create debris along the cutting street/trajectory (e.g. composed of ejected particles of transparent material) that impacts the quality of the edge and the sidewall of the cut geometry and contaminates the surface of the cut part around the cutting street (e.g., in terms of dimensional accuracy, sidewall smoothness, and/or the like). Further, in many cases, the existing laser-cutting systems create a heat affected zone that extends beyond the geometry being cut, which may damage an area along the cutting street/trajectory of the geometry.

Some implementations described herein provide a cutting system that uses an ultrafast laser light source generating bursts of ultrafast laser-pulses to generate a Bessel beam to cut or modify a transparent material, such as glass. In some implementations, the laser cutting system may be configured to generate the Bessel beam by using an axicon, a first lens, and a second lens. In some implementations, the laser light source may be configured to provide one or more ultrashort laser pulses to generate one or more respective Bessel beams to cut the transparent material. In some implementations, a Bessel beam may be configured to cut a hole in the transparent material by vaporizing transparent material within a depth of field of the Bessel beam, which may prevent debris from accumulating in the hole and impacting the quality of the hole. In some implementations, a Bessel beam may be configured to generate a heat affected zone that is smaller in area than a heat affected zone generated by the existing laser-based cutting systems, which may result in less damage to surrounding areas of the geometry cut by the cutting system.

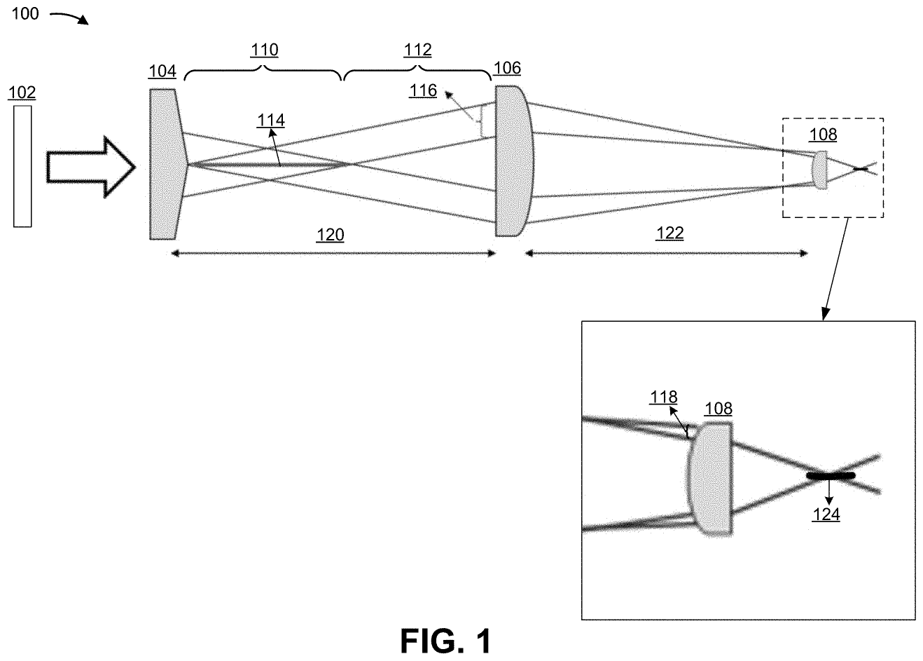

FIG. 1 is a diagram of an example Bessel beam cutting system 100 described herein. As shown in FIG. 1, the Bessel beam cutting system may include a light source 102, an axicon 104, a first lens 106, and/or a second lens 108.

The light source 102 may be configured to emit an input beam into the axicon 104. The input beam may be a laser beam, such as a laser beam with a wavelength range in the visible and near-infrared spectrum. For example, the light source 102 may be a Gaussian laser light source configured to emit a Gaussian laser beam (e.g., a laser beam with a Gaussian intensity profile) into the axicon 104. As another example, the light source 102 may be a top-hat laser light source configured to emit a top-hat laser beam (e.g., a laser beam with a top-hat intensity profile) into the axicon 104. The light source 102 may be configured to emit the input beam into the axicon 104 at an angle to an input surface of the axicon 104. For example, the light source 102 may be configured to emit the input beam into the axicon 104 at a 90 degree angle (e.g., within a suitable tolerance, such as two degrees) to the input surface of the axicon 104.

The axicon 104 may be configured to have an output surface that includes an apex of the axicon 104. The output surface of the axicon 104 may be defined by an apex angle of the apex. For example, the apex angle of the axicon 104 may be configured to be within a range of 100 to 180 degrees (e.g., the apex angle may be configured to be greater than or equal to 100 degrees and less than 180 degrees). Additionally, or alternatively, the axicon 104 may not include an apex angle, but instead include one or more diffractive optical elements.

The input beam (e.g., emitted by the light source 102) may enter the axicon 104 via the input surface of the axicon 104 and propagate through the axicon 104 (e.g., via refraction and/or diffraction and due to the apex angle of the axicon 104) to the output surface of the axicon 104. As a result, the axicon 104 may be configured to emit, from the output surface of the axicon 104, an output beam comprising a Bessel beam in a near field 110 of the axicon 104 and an annular beam in a far field 112 of the axicon 104. The Bessel beam may have a depth of field 114. The annular beam may have an annular width 116. A divergence angle of the output beam from the output surface of the axicon 104 depends on the apex angle of the axicon 104. For example, a larger apex angle of the axicon 104 results in a larger convergence in the near field 110 and a larger divergence in the far field 112, resulting in a larger divergence angle of the output beam from the output surface of the axicon 104. Conversely, a smaller apex angle of the axicon 104 results in a smaller divergence angle of the output beam from the output surface of the axicon 104.

The axicon 104 may be configured to emit the Bessel beam and/or the annular beam into an input surface of the first lens 106 (e.g., a convex lens or a positive lens). The first lens 106 may be configured to focus the Bessel beam and/or the annular beam and to emit, from an output surface of the first lens 106, a focused Bessel beam and/or annular beam that has an annular width 118.

The first lens 106 may be configured to be a distance 120 from the axicon 104. A focal length of the first lens 106 may depend on the apex angle of the axicon 104. For example, the first lens 106 should be configured with a short focal length to enable convergence of the Bessel beam and/or annular beam emitted from the axicon 104 for a larger apex angle axicon 104. Additionally, the distance 120 may be configured to correspond to the clear aperture of the first lens 106. For example, the distance 120 may be configured to be within a suitable range in order to not cut the output beam from the axicon 104.

The first lens 106 may be configured to emit the focused Bessel beam and/or annular beam into an input surface of the second lens 108 (e.g., a convex lens or a positive lens). The second lens 108 may be configured to be a distance 122 from the first lens 106. The distance 122 may be configured to correspond to a focal length (FL1) of the first lens 106 and/or a focal length (FL2) of the second lens 108. For example, the distance may be the focal length of the first lens 106 added to 1.5 times the focal length of the second lens 108 (e.g., distance 122=FL1+(1.5×FL2)).

The second lens 108 may be configured to converge the focused Bessel beam and/or annular beam into an secondary Bessel beam (e.g., in a near field of the second lens 108). The secondary Bessel beam may be configured to have a depth of field 124.

In this way, the first lens 106 and the second lens 108 may be configured to be used in conjunction to magnify (or demagnify) the Bessel beam and/or the annular beam into the secondary Bessel beam. In some implementations, the first lens 106 and the second lens may be configured to provide an axial magnification amount within a range of 1/2500 to 1 (e.g., the axial magnification amount may be configured to be greater than or equal to 1/2500 and less than or equal to 1). In some implementations, the axial magnification amount of the first lens 106 and the second lens 108 may be configured to correspond to a ratio between the length of the depth of field 114 of the Bessel beam and the length of the depth of field 124 of the secondary Bessel beam. For example, the axial magnification amount may be configured to be the ratio of the length of the depth of field 114 of the Bessel beam divided by the length of the depth of field 124 of the secondary Bessel beam. In some implementations, the focal length of the first lens 106, the focal length of the second lens 108, the distance 120, and the distance 122, and/or the like may be adjusted to provide the axial magnification amount that corresponds to the ratio.

In some implementations, one or more parameters related to the light source 102, the axicon 104, the first lens 106, and/or the second lens 108 may be configured to control characteristics of the input beam, the Bessel beam, the annular beam, the focused Bessel beam and/or annular beam, and/or the secondary Bessel beam. For example, the one or more parameters may be configured to cause a diameter of the input beam to be within the clear aperture of axicon 104 (e.g., the diameter of the input beam may be configured to be less than or equal to 22.8 millimeters for a 85% clear aperture of a 1 inch axicon); the length of the depth of field 114 of the Bessel beam may be configured to be within a range of 10 millimeters in air to 1 meter (e.g., the length of the depth of field 114 may be configured to be greater than or equal to 10 mm in air and less than or equal to 1 meter in air); the length of the depth of field 124 of the secondary Bessel beam may be configured to be within a range of 30 micrometers (μm) and 15 mm in air (e.g., the length of the depth of field 124 may be configured to be greater than or equal to 30 μm in air and less than or equal to 15 mm in air); and/or the like.

In a first configuration example, the light source 102 may be configured to emit an input beam with a diameter of 3 mm, the axicon 104 may be configured to have an apex angle of 178 degrees, and the first lens 106 and the second lens 108 may be configured to provide an axial magnification amount of 1/280. This may create a Bessel beam with a depth of field of 114 that has a length of 190 mm in air, an annular beam with an annular width 116 of 1.5 mm, and a secondary Bessel beam with a depth of field 124 that has a length of 400 μm in air. In a second configuration example, which is a modification of the first configuration example, the light source 102 may be configured to emit an input beam with a diameter of 15 mm, which increases the length of the depth of field 114 of the Bessel beam to be 950 mm in air and the length of the depth of field 124 of the secondary Bessel beam to be 2 mm in air. In a third configuration example, the light source 102 may be configured to emit an input beam with a diameter of 20 mm, the axicon 104 may be configured to have an apex angle of 170 degrees, and the first lens 106 and the second lens 108 may be configured to provide an axial magnification amount of 1/25, which increases the length of the depth of field 124 of the secondary Bessel beam to be 10 mm in air. Other configuration examples are contemplated.

In some implementations, the one or more parameters related to the light source 102, the axicon 104, the first lens 106, and/or the second lens 108 may be configured to control a form factor length (e.g., a distance from the light source 102 to the second lens 108) of the Bessel beam cutting system 100. For example, the axicon 104 may be configured to have a small apex angle, such as 170 degrees, which may cause the length of the depth of field 124 of the Bessel beam to be short (e.g., shorter than a length of 190 mm (e.g., in the air) of the depth of field 124 of the Bessel beam when the axicon 104 has an apex angle of 178 degrees, as described in the first configuration example herein). This may allow the first lens 106 to be moved closer to the axicon 104, which may shorten the distance 120 between the axicon 104 and the first lens 106. Further, the first lens 106 and the second lens 108 may be configured to have small focal lengths, such as a 30 mm focal length for the first lens 106 and an 8 mm focal length for the second lens 108, which may shorten the distance 122 between the first lens 106 and the second lens 108 (e.g., according to the formula described above, the distance 122=30 mm+(1.5×8 mm)=42 mm). Accordingly, in some implementations, the form factor length (e.g., the distance from the light source 102 to the second lens 108) of the Bessel beam cutting system 100 may be configured to be less than or equal to 100 mm.

In some implementations, the Bessel beam cutting system 100 may be configured to cut transparent materials such as glass, sapphire, silicon, and/or other transparent materials (e.g., green transparent materials, red transparent materials, non-ultraviolet (UV) blue transparent materials, and/or the like). For example, the Bessel beam cutting system 100 may be configured to direct the secondary Bessel beam toward a transparent workpiece to cut a particular geometry in the workpiece. In some implementations, the workpiece may be placed a particular distance away from the second lens 108 to allow the transparent workpiece to be coextensive with the depth of field 124 of the secondary Bessel beam. This may allow the elongated focal area of the depth of field 124 of the secondary Bessel beam to cut the workpiece by causing a uniform distribution of laser-supplied energy within the workpiece.

In some implementations, the secondary Bessel beam may be configured to have a cutting depth and/or modification depth that is within a range of tens of micrometers to several millimeters in the transparent material (e.g., 20 micrometers to 10 millimeters in the transparent material). For example, the cutting depth and/or modification depth may be 0.3 mm to 1 mm (e.g., the cutting depth may be configured to be greater than or equal to 0.3 mm and less than or equal to 1 mm) in a transparent material (e.g., glass, silicon, sapphire, and/or the like that may be transparent for a wavelength associated with the input beam). For example, the secondary Bessel beam may be configured to have a cutting depth and/or modification depth of 0.3 mm in float glass when the length of the depth of field 124 of the additional Bessel beam is 400 μm in air (e.g., as described herein in the first configuration example). As another example, the secondary Bessel beam may be configured to have a cutting depth and/or modification depth of 1 mm in float glass when the length of the depth of field 124 of the additional Bessel beam is 2 mm in air (e.g., as described herein in the second configuration example).

In some implementations, the light source 102 may be configured to be an ultrafast laser light source (e.g., configured with a burst mode, such as a flat burst mode (e.g., a burst of pulses where all individual pulses within the burst have the same pulse energy), a declining burst mode, a jagged burst mode, and/or the like) to provide one or more respective ultrashort laser pulses (e.g., laser pulses that last from attoseconds to nanoseconds) as one or more input beams. A burst of ultrafast laser pulses may be a sequence of pulses where a temporal spacing between the pulses is below a pulse-period of a burst repetition rate (e.g., when a frequency of a burst is 100 kHz (i.e. a pulse/burst period is 10 μs), a temporal pulse-to-pulse distance within the burst may be less than 10 μs, such as 12 ns).

The one or more input beams may propagate through the Bessel beam cutting system 100 as described herein and into a workpiece (e.g., a transparent workpiece) to generate an optical filament in the workpiece (e.g., because of focusing the high-power-density of the depth of field 124 of the additional Bessel beam into the workpiece). An ultrashort laser pulse may be configured to have a burst energy within a range of 50 microjoules (μJ) to 2 mJ; a power within a range of 8 watts (W) to 200 W; and a repetition rate within a range of 50 kilohertz (kHz) to 500 kHz. For example, an ultrashort laser pulse may be configured to have a burst energy within a range of 100 μJ to 250 μJ; a power within a range of 8 W to 20 W; a repetition rate with a range of 70 kHz to 80 kHz.

For example, the light source 102 may be configured to generate a burst of ultrashort laser pulses (e.g., of equal energy with an intraburst temporal pulse spacing of e.g. 12 ns, such as in a flat burst mode), where the burst of ultrashort laser pulses has a combined burst-energy of 100 μJ, a power of 8 W, and/or frequency of 80 kHz, which may enable the secondary Bessel beam to cut the workpiece to a depth of 0.3 mm (e.g., when the light source 102, the axicon 104, the first lens 106, and/or the second lens 108 are configured as described herein with regard to the first configuration example). As another example, the light source 102 may be configured to generate a burst of ultrashort laser pulses of equal energy (e.g., in a flat burst mode), where the burst of ultrashort laser pulses has a combined burst-pulse energy of 250 μJ, a power of 20 W, and/or a frequency of 80 kHz, which may enable the additional Bessel beam to cut the workpiece to a depth of 1 mm (e.g., when the light source 102, the axicon 104, the first lens 106, and/or the second lens 108 are configured as described herein with regard to the second configuration example).

In some implementations, the Bessel beam cutting system 100 and/or the workpiece may be configured to move relative to each other (e.g., the Bessel beam cutting system may move the Bessel beam cutting system 100 sideways or may move the workpiece sideways). The Bessel beam cutting system 100, by generating an optical filament in the workpiece, may create a “line” of defects through the bulk of the transparent material (e.g., normal to the surface of the material). By moving the workpiece sideways relative to the Bessel beam cutting system 100, multiple defect “lines” may be created next to each other in such a way that the created defects connect. As a result the Bessel beam cutting system 100 to create an energy curtain inside the bulk of the workpiece. The energy curtain may cause the workpiece to crack, which may prepare the workpiece for mechanical or thermal separation.

As indicated above, FIG. 1 is provided merely as one or more examples. Other examples may differ from what is described with regard to FIG. 1.

The foregoing disclosure provides illustration and description, but is not intended to be exhaustive or to limit the implementations to the precise forms disclosed. Modifications and variations may be made in light of the above disclosure or may be acquired from practice of the implementations.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A Bessel beam laser-cutting system comprising:
an ultrafast laser light source configured to emit a beam into an axicon;
the axicon configured to diffract the beam into a first Bessel beam in a near field of the axicon and an annular beam in a far field of the axicon;
a first lens configured to focus the annular beam; and
a second lens configured to converge the focused annular beam into a second Bessel beam to modify a transparent material,
wherein a depth of the modification generated by the second Bessel beam is to be within a range of tens of micrometers to several millimeters inside the transparent material.

2. The Bessel beam laser-cutting system of claim 1, wherein:
a diameter of the beam is to be 3 millimeters;
an apex angle of the axicon is configured to be 178 degrees;
a length of a depth of field of the first Bessel beam is to be 190 millimeters in air;
an annular width of the annular beam is to be 1.5 millimeters;
an axial magnification amount of the annular beam by the first lens and the second lens is to be 1/280;
a length of a depth of field of the second Bessel beam is to be 400 micrometers in air; and
the depth of the modification generated by the second Bessel beam is to be 0.3 millimeters in the transparent material.

3. The Bessel beam laser-cutting system of claim 1, wherein:
a diameter of the beam is to be 15 millimeters;
an apex angle of the axicon is configured to be 178 degrees;
a length of a depth of field of the first Bessel beam is to be 950 millimeters in air;
a length of a depth of field of the second Bessel beam is to be 2 millimeters in air; and
the depth of the modification generated by the second Bessel beam is to be 1 millimeter in the transparent material.

4. The Bessel beam laser-cutting system of claim 1, wherein:
a diameter of the beam is to be 3 millimeters;
an apex angle of the axicon is configured to be 178 degrees;
a length of a depth of field of the first Bessel beam is to be 190 millimeters in air;
an annular width of the annular beam is to be 1.5 millimeters;
an axial magnification amount of the annular beam by the first lens and the second lens is to be 1/100;
a length of a depth of field of the second Bessel beam is to be 2 millimeters in air; and
the depth of the modification generated by the second Bessel beam is to be 1 millimeter in the transparent material.

5. The Bessel beam laser-cutting system of claim 1, wherein the ultrafast laser light source is configured to emit a burst of ultrashort laser pulses as the beam, and wherein:
a burst energy associated with the burst of ultrashort laser pulses is to be within a range of 100 microjoules to 250 microjoules;
a power associated with the burst of ultrashort laser pulses is to be within a range of 8 watts to 20 watts; and
a repetition rate associated with the burst of ultrashort laser pulses is to be within a range of 70 kilohertz to 80 kilohertz.

6. The Bessel beam laser-cutting system of claim 1, wherein the beam is to have a Gaussian intensity profile or a top-hat intensity profile.

7. The Bessel beam laser-cutting system of claim 1, wherein the first lens is configured to be a convex lens and the second lens is configured to be a concave lens.

8. The Bessel beam laser-cutting system of claim 1, wherein a form factor length of the Bessel beam laser-cutting system is to be less than or equal to 100 millimeters.

9. A cutting system for transparent materials comprising:
an ultrafast laser light source configured to emit an ultrashort laser pulse into an axicon;
the axicon configured to diffract the ultrashort laser pulse into a first Bessel beam in a near field of the axicon and an annular beam in a far field of the axicon,
wherein a length of a depth of field of the first Bessel beam is to be within a range of 10 millimeters in air to 1 meter in air;
a first lens configured to focus the annular beam; and
a second lens configured to converge the focused annular beam into a second Bessel beam to modify a transparent material,
wherein a length of a depth of field of the second Bessel beam is to be within a range of 30 micrometers in air to 15 millimeters in air, and
wherein a cutting depth of the second Bessel beam is to be within a range of 20 micrometers to 10 millimeters in the transparent material.

10. The cutting system for transparent materials of claim 9, wherein the ultrafast light source is configured to emit the ultrashort laser pulse in a burst mode.

11. The cutting system for transparent materials of claim 9, wherein an apex angle of the axicon is configured to be within a range of 170 to 180 degrees.

12. The cutting system for transparent materials of claim 9, wherein:
an energy of the ultrashort laser pulse is to be within a range of 100 microjoules to 250 microjoules; and
a power of the ultrashort laser pulse is to be within a range of 8 watts to 20 watts.

13. The cutting system for transparent materials of claim 9, wherein:
an apex angle of the axicon is configured to be 170 degrees a focal length of the first lens is configured to be 30 millimeters;
a focal length of the second lens is configured to be 8 millimeters; and
the cutting depth of the second Bessel beam is to be 1 millimeter in the transparent material.

14. The cutting system for transparent materials of claim 9, wherein the first lens is configured to be a distance from the axicon, and
wherein the distance is to correspond to a numerical aperture of the first lens.

15. The cutting system for transparent materials of claim 9, wherein the second lens is configured to be a distance from the first lens, and
wherein the distance is to correspond to a focal length of the first lens and a focal length of the second lens.

16. A Bessel beam cutting system comprising:
a light source configured to emit a beam into an axicon,
wherein a diameter of the beam is associated with a clear aperture of the axicon;
the axicon configured to diffract the input beam into a first Bessel beam in a near field of the axicon and an annular beam in a far field of the axicon,
wherein an apex angle of the axicon is configured to be within a range of 100 to 180 degrees; and
a first lens and a second lens configured to demagnify the annular beam into a second Bessel beam to modify a transparent material,
wherein an axial magnification amount of the annular beam by the first lens and the second lens is configured to be within a range of 1/2500 to 1, and
wherein a modification depth of the second Bessel beam is to be within a range of 30 micrometers to 10 millimeters in the transparent material.

17. The Bessel beam cutting system of claim 16, wherein the axial magnification amount of the annular beam by the first lens and the second lens is to correspond to a ratio between a length of a depth of field of the first Bessel beam and a length of a depth of field of the second Bessel beam.

18. The Bessel beam cutting system of claim 16, wherein a focal length of the first lens is configured to be 30 millimeters, a focal length of the second lens is configured to be 8 millimeters, and a distance between the first lens and the second lens is configured to be 42 millimeters.

19. The Bessel beam cutting system of claim 16, wherein a length of a depth of field of the second Bessel beam is to be within a range of 400 micrometers in air to 2 millimeters in air.

20. The Bessel beam cutting system of claim 16, wherein the second Bessel beam is to create an energy curtain within the glass to prepare the glass for mechanical or thermal separation.
